(19) United States
(12) Patent Application Publication
(10) Pub. No.: US 2010/0075114 A1
(43) Pub. Date: Mar. 25, 2010

(54) MOLD FOR OPTICAL ELEMENT, HAVING NANOSTRUCTURE, MOLD FOR NANOSTRUCTURE, METHOD FOR MANUFACTURING THE MOLD, AND OPTICAL ELEMENT

(75) Inventors: Kazuma KURIHARA, Tsukuba-shi (JP); Takayuki SHIMA, Tsukuba-shi (JP); Junji TOMINAGA, Tsukuba-shi (JP)

Correspondence Address: VENABLE LLP, P.O. BOX 34385, WASHINGTON, DC, 20043-9998, US

(73) Assignee: National Institute of Advanced Industrial Science and Technology, Tokyo (JP)

(21) Appl. No.: 12/519,052

(22) PCT Filed: Dec. 3, 2007
(86) PCT No.: PCT/JP2007/073321

§ 371 Date: Jun. 12, 2009

(30) Foreign Application Priority Data
Dec. 13, 2006 (JP) 2006-335311
Apr. 19, 2007 (JP) 2007-109956

(51) Int. Cl. B28B 7/36; B29D 11/00; B32B 5/00

(52) U.S. Cl. 428/195.1; 216/41; 249/114.1; 977/888; 977/700

(57) ABSTRACT

This invention provides a method for manufacturing a mold for an optical element having a nanostructure of nano-order fine depressions and elevations on a surface of a substrate. The method includes: forming at least one etching transfer layer on the substrate, and forming a thin film for hemispherical fine particle formation on the etching transfer layer; forming multiple hemispherical island-shaped fine particles, with any of thermal-, photo- and gas reactions or combination thereof to cause any of aggregation, decomposition and nucleation functions of a material of the thin film; and forming a conical pattern on the fine surface of the substrate, by successively etching the etching transfer layer and the substrate with a reactant gas, using the multiple island-shaped fine particles as a protective mask, thereby manufacturing a mold for an optical element having fine depressions and elevations or a nanostructure mold face on the surface of the substrate.

### TECHNICAL FIELD

The present invention relates to a mold for an optical element having a nanostructure for use in high-sensitivity detection in the biological or medical field or a mold for a nanostructure, a method for manufacturing the mold, and an optical element. The mold for a nanostructure subsumes “the mold for an optical element having a nanostructure.”

As employed herein, “the nanostructure” refers to a nanostructure with a high aspect ratio for use in high-sensitivity detection in the biological or medical field, and “the mold for a nanostructure” refers to a mold for use in molding such a nanostructure with a high aspect ratio. Meanwhile, the nanostructure can be employed, for example, in heat dissipation control, heat conduction control for a substance, or wettability control.

As employed herein, “the optical element having a nanostructure” refers to a sensing chip or the like for use in high-sensitivity detection in the biological or medical field, and “the mold for an optical element having a nanostructure” refers to a mold for use in molding such a sensing chip or the like.

### BACKGROUND ART

Heretofore, a nanostructure has enabled an improvement in detection sensitivity of an optical element for use in fluorescence analysis, polarimetry, or the like in the biological or medical field. Thus, surface treatment is given to a substrate surface in order to achieve high detection sensitivity. As a specific method for the surface treatment, a method is known for forming fine and dense depressions and elevations on the substrate surface.

The provision of the periodic depressions and elevations on the substrate surface as mentioned above enables a dramatic increase in the surface area of the substrate and hence a great improvement in the detection sensitivity (See Patent Documents 1 and 2, for example).

Achievement of such a fine nanostructure requires a fine pattern equal to or smaller than wavelength, and thus, a method for fabricating such a fine structure is known to use electron beam lithography. This method involves: applying an electron beam resist; thereafter, giving patterning using an electron beam; and subjecting the substrate to a process (i.e., an etching process) using reactive etching.

It is also known that a fine nanostructure can be fabricated by using anodized porous alumina to fabricate a nano-periodic structure (See Patent Document 3 or 4, for example). The fabrication method using the anodized porous alumina involves subjecting aluminum to anodic oxidation in a strongly acidic solution such as a sulfuric acid, thereby causing the self-formation of periodic nanoholes in the aluminum surface.

Patent Document 1: Japanese Patent Laid-Open No. 2006-300726

Patent Document 2: Japanese Patent Laid-Open No. 2005-337771

Patent Document 3: Japanese Patent Laid-Open No. 2006-62049

Patent Document 4: Japanese Patent Laid-Open No. 2006-68827

### DISCLOSURE OF THE INVENTION

### Problems to be Solved by the Invention

However, the method using an electron beam lithography system for fabricating the nanostructure has an extremely slow rate of lithography throughput and hence takes time to form a pattern, because the electron beam is scanned for the patterning. This also leads to a problem of a rise in cost for adaptation to an optical element having a large area.

Meanwhile, the method using the anodized porous alumina for fabricating a fine nanostructure has a problem of limitation on material for the substrate, although being able to form a periodic nanostructure with a large area at a time.

Further, the method using the anodized porous alumina has a problem of requiring high-precision voltage-current control for fabricating a uniform nanostructure in a large area. In addition, the method presents a problem of having difficulty in achieving reproducibility, since processing conditions vary according to the size of the substrate or the area to be processed.

The present invention is intended to solve the foregoing problems. An object of the present invention is to achieve a mold for an optical element having a nanostructure, a mold for a nanostructure, a method for manufacturing the mold, and an optical element, as given below.

(1) A mold for an optical element having a nanostructure or the mold for a nanostructure according to the present invention enables a further improvement in detection sensitivity of an optical element having a uniform and stabile nanostructure formed of a structure having a large area and also a complicated shape, on a substrate surface, the optical element being for use in fluorescence analysis, polarimetry, or the like in the biological or medical field.

(2) A method for manufacturing the mold for an optical element or a nanostructure according to the present invention is capable of manufacture involving a small number of steps and also using a dry process alone which is high in productivity.

(3) An optical element according to the present invention has a nanostructure formed of fine depressions and elevations on a surface of a substrate, and includes nanopatterns with a high aspect ratio in random arrangements. Preferably, the optical element includes nanopatterns which are maintained at intervals equal to or less than the wavelength of a light source.

### Means for Solving the Problems

In order to attain the above object, the present invention provides a method for manufacturing a mold for an optical element having a nanostructure or a mold for a nanostructure, for use in molding of an optical element having a nanostructure formed of fine depressions and elevations on a surface of a substrate, characterized by comprising: forming at least one etching transfer layer on the substrate, and forming a thin film for island-shaped fine particle formation on the etching transfer layer; forming a plurality of island-shaped fine particles, by subjecting the thin film to any one of a thermal reaction, a photoreaction and a chemical reaction or to a combination reaction of these reactions thereby to cause any one of aggregation, decomposition, and nucleation of a material of the thin film; and forming a convex pattern with a high aspect ratio on the fine surface of the substrate, by successively etching the etching transfer layer and the substrate using the plurality of island-shaped fine particles as a protective mask.

Preferably, the multiple island-shaped fine particles are of sizes of the order of nanometers, so that nanopatterns are formed in random arrangements with intervals therebetween each maintained to be equal to or less than a wavelength of a target light source.

Preferably, a material for the thin film is a substance containing any one of silver, gold, platinum and palladium as a main component, or is any one of an oxide and a nitride each containing any one of silver, gold, platinum, palladium, tungsten, bismuth and tellurium as a main component.

Preferably, the island-shaped fine particles have an average particle diameter of 5 nm to 1000 nm, and an average interval between the pluralities of island-shaped fine particles is 10 nm to 2000 nm.

Preferably, the substrate is made of any one of a metal and a nonmetal containing any one of silica glass, resin, silicon, gallium nitride, gallium arsenide, indium phosphide, nickel, iron, titanium, carbon, sapphire and carbon nitride as a main component.

Preferably, the etching transfer layer is constructed of a single layer formed of any one of an oxide, a nitride and a carbide, or is constructed of multiple layers each formed of any one of an oxide, a nitride and a carbide.

In order to attain the above object, the present invention provides a mold for an optical element having a nanostructure or for a nanostructure, manufactured by the method for manufacturing a mold for an optical element.

In order to attain the above object, the present invention provides an optical element characterized by having a nanostructure formed of fine depressions and elevations on a surface of a substrate and comprising nanopatterns with a high aspect ratio in random arrangements.

Preferably, the nanopatterns of the optical element having a nanostructure are maintained at intervals equal to or less than a wavelength of a light source.

### Effects of the Invention

The present invention produces the following effects.

(1) The mold for an optical element according to the present invention has a uniform and stable nanostructure on a substrate surface that is a complicated free curved surface with a large area and is capable of manufacturing a high-sensitivity sensor chip with a large area for use in biological or medical applications at lower cost.

(2) The method for manufacturing a mold for an optical element having a nanostructure or a mold for a nanostructure according to the present invention is capable of manufacture involving a small number of steps and also using a dry process alone which is high in productivity.

(3) The optical element according to the present invention has a nanostructure formed of fine depressions and elevations on a surface of a substrate, and includes nanopatterns with a high aspect ratio in random arrangements. Preferably, the optical element includes nanopatterns which are maintained at intervals equal to or less than the wavelength of a light source.

### BRIEF DESCRIPTION OF THE DRAWINGS

FIG. 1 is a view explaining a first embodiment of the present invention;

FIG. 2 is a view explaining the first embodiment of the present invention;

FIG. 3 is a view explaining the first embodiment of the present invention;

FIG. 4 is a view explaining a second embodiment of the present invention;

FIG. 5 is a view explaining the manufacture of an injection mold utilizing a mold for an optical element having a nanostructure according to the first embodiment of the present invention, the molding of the nanostructure utilizing the same, and the optical element; and

FIG. 6 is a view explaining the manufacture of an injection mold utilizing a mold for an optical element having a nanostructure according to the second embodiment of the present invention, the molding of the optical element having the nanostructure utilizing the same, and the optical element.

### EXPLANATION OF REFERENCE NUMERALS

1 . . . mold for optical element having nanostructure,
2 . . . substrate,
3 . . . etching transfer layer,
4 . . . thin film for island-shaped fine particle formation,
5 . . . island-shaped fine particle,
6 . . . mold for optical element having nanostructure,
7 . . . substrate,
8 . . . injection mold,
9 . . . optical element having nanostructure,
10 . . . injection mold,
11 . . . optical element having nanostructure

### BEST MODE FOR CARRYING OUT THE INVENTION

Description will be given below with reference to the drawings with regard to best mode for carrying out a mold for an optical element having a nanostructure or a mold for a nanostructure, a method for manufacturing the mold, and an optical element according to the present invention, on the basis of embodiments.

The present invention provides a mold for an optical element or a mold for a nanostructure, for molding an optical element having on its surface a fine depressions and elevations structure (i.e., a nanostructure) for the purpose of achieving a high-sensitivity sensing effect for biological, medical or other applications, and a method for manufacturing the mold. Processes in the method for manufacturing the mold for the optical element according to the present invention are as follows.

(1) A process for Thin Film Formation on Substrate

Multiple etching transfer layers are formed on a substrate, and further, thin films are formed at a time. A vacuum dry process is used for the formation process.

### (2) Nanopattern Formation

Nanopatterns such that island-shaped fine particles of minute sizes of the order of nanometers and in hemispherical shape are randomly arranged at intervals equal to or less than the wavelength of a target light source are formed by utilizing any one of a thermal reaction, a photoreaction and a gas reaction or utilizing a combination reaction of two or more of these reactions thereby to cause any one of aggregation, decomposition and nucleation of a material of construction of the thin film.

A material containing any one of silver, gold, platinum and palladium as a main component, or any one of an oxide material and a nitride containing any one of silver, gold, platinum, palladium, tungsten, bismuth and tellurium as a main component may be used as a material for the island-shaped fine particles thereby to form nanopatterns such that the intervals between the multiple island-shaped fine particles are narrow. At this time, preferably, the hemispherical island-shaped fine particles have an average particle diameter of 5 nm to 1000 nm, and an average interval between the adjacent island-shaped fine particles is 10 nm to 2000 nm inclusive.

(3) A fine conical nanostructure is formed on the surface of the substrate, by subjecting the etching transfer layer to etching and further subjecting the finally targeted substrate to etching, using the formed nanopatterns, that is, using the island-shaped fine particles as a protective mask. Thereby, the mold for an optical element having a nanostructure or the mold for a nanostructure is fabricated.

In this case, the provision of the multiple etching transfer layers between the island-shaped substance and the substrate, as mentioned above, enables effective fabrication of fine depressions and elevations (or a nanostructure mold face) capable of molding an optical element having a nanostructure with a high aspect ratio, on the surface of the mold for an optical element.

As will be described with reference to the following embodiments, when the mold for an optical element is used, the optical element according to the present invention has a nanostructure formed of fine depressions and elevations on a surface of a substrate, and includes nanopatterns with a high aspect ratio in random arrangements. Preferably, the optical element includes nanopatterns arranged which are maintained at intervals equal to or less than the wavelength of a light source.

### First Embodiment

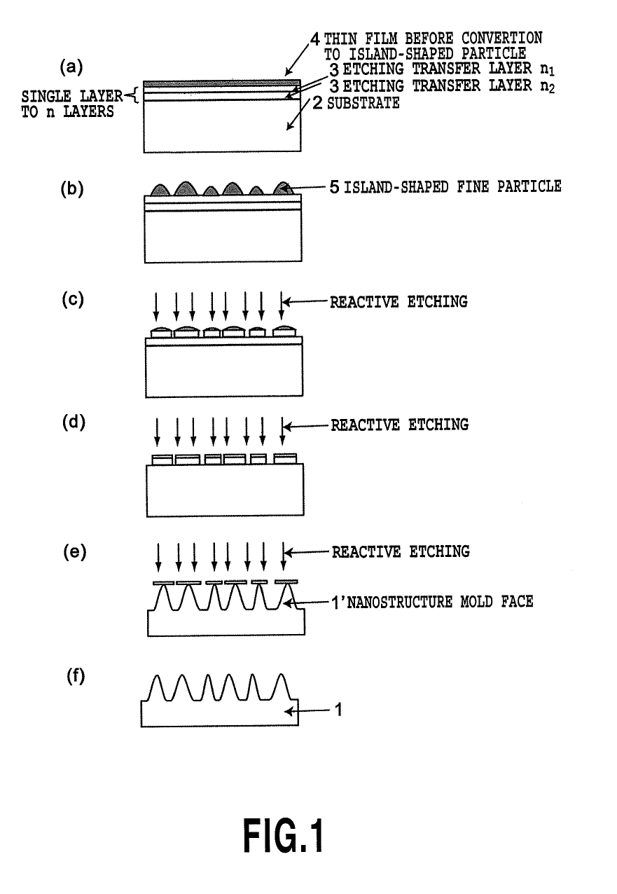

Detailed description will be given below with reference to the drawings with regard to a first embodiment of the mold for an optical element and the method for manufacturing the mold according to the present invention. FIG. 1 is a view explaining processes in a method for manufacturing a mold 1 for an optical element according to the first embodiment of the present invention, using reactive ion etching.

(1) An etching transfer layer 3 formed of at least one layer, and a thin film 4 for island-shaped fine particle formation are formed on a surface of a flat substrate 2 (see FIG. 1(a)) by using a film formation apparatus (not shown). Through verification tests, the inventors have verified that a substance containing any one of silver, gold, platinum and palladium as a main component is effective for a material for the thin film 4 for forming island-shaped fine particles 5 in random arrangements at intervals equal to or less than the wavelength of a target light source, on the surface of the substrate 2.

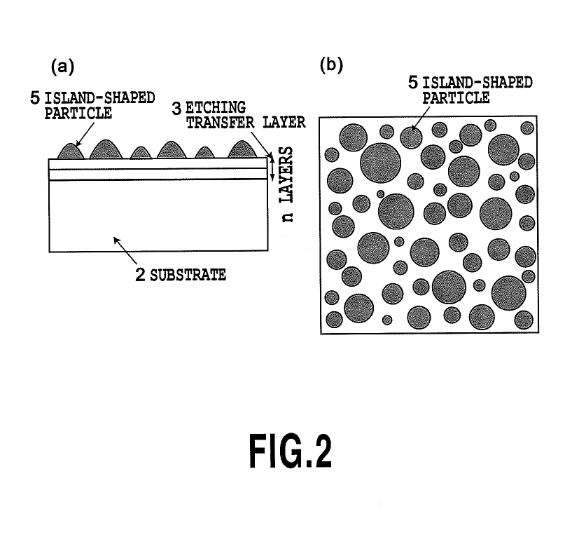

(2) Then, the island-shaped fine particles 5 randomly arranged at intervals equal to or less than the wavelength are fabricated by utilizing any one of aggregation, nucleation and decomposition (see FIG. 1(b)). FIGS. 2(a) and 2(b) are a sectional view and a plan view, respectively, showing the substrate 2 and the island-shaped fine particles 5 formed on the etching transfer layer 3.

Incidentally, a thermal reaction, a photoreaction, a gas reaction, or the like may be used as a parameter thereby to control an aggregation reaction or a nucleation reaction of the material and thereby control an average particle diameter of the island-shaped fine particles 5 or the intervals between the island-shaped fine particles 5. Meanwhile, the inventors have verified that the material for the thin film 4 may be doped with an impurity thereby to control the average particle diameter of the island-shaped fine particles 5 or the intervals between the island-shaped fine particles 5.

When an oxide containing any one of silver, gold, platinum, palladium, tungsten, bismuth and tellurium as a main component is used, heat, light or a gas decomposition may be used thereby to control the average particle diameter of the island-shaped fine particles 5 or the intervals between the island-shaped fine particles 5.

(3) Then, the etching transfer layer 3 is subjected to etching, using a reactant gas (for example, CF₄, CHF₃, CH₄, C₂F₆, H₂, CO, NH₃, Cl₂, or BCl₃), using the formed island-shaped fine particles 5 as masking (see FIG. 1(c)). Here, the etching transfer layer 3 is subjected to the etching, while maintaining the same shape as the island-shaped fine particles 5, and successively functions as a masking layer for the next etching transfer layer 3 or the substrate 2.

When the island-shaped fine particles 5 are used to form on the surface of the substrate 2 substantially conical fine depressions and elevations (or a nanostructure mold face) 1′ for formation of the nanostructure on the surface of the optical element, the provision of the etching transfer layer 3, as mentioned above, enables fabrication of a substantially conical structure with a high aspect ratio. For a material for the etching transfer layer 3, a material containing carbon as a main component, silicon, silicon oxide, silicon nitride, or the like is effective, for example when the island-shaped fine particles 5 containing silver as the main component are used for the masking layer.

Here, when the island-shaped fine particles 5 contain silver as the main component, the etching transfer layer 3 is made of carbon and the substrate 2 is made of quartz, reactive etching is performed using a gas species which provides the relationship “the etching rate of the island-shaped fine particles 5”<<“the etching rate of the etching transfer layer 3”. Thereby, the island-shaped fine particles 5 can produce a masking effect, and thus, a pattern can be formed on the etching transfer layer 3.

Then, in a case of the etching of the etching transfer layer 3 and the substrate 2, reactive etching is performed using a gas species which provides the relationship “the etching rate of the etching transfer layer 3”<<“the etching rate of the substrate 2”. This enables fabrication of a substantially conical nanostructure masked on the basis of the island-shaped fine particles 5 on the surface of the substrate 2. Meanwhile, the etching transfer layer 3 is not limited to a single layer, and may be fabricated in multiple layers in accordance with process design for etching.

The second and following etching transfer layers 3 are subjected to the same process (see FIG. 1(d)), and finally, the substrate 2 is subjected to etching. Thereby, the mold 1 for the optical element having the substantially conical fine depressions and elevations (or the nanostructure mold face) 1′ formed on the surface of the substrate 2 is formed (see FIG. 1(f)).

The use of the above-described method enables, using a dry process alone, the surface of the substrate 2 to have the fine depressions and elevations densely randomly formed at intervals equal to or less than the wavelength of the target light source. Thereby, even an optical substrate having a complicated shape can be easily fabricated, and also, a fabrication process can be simplified.

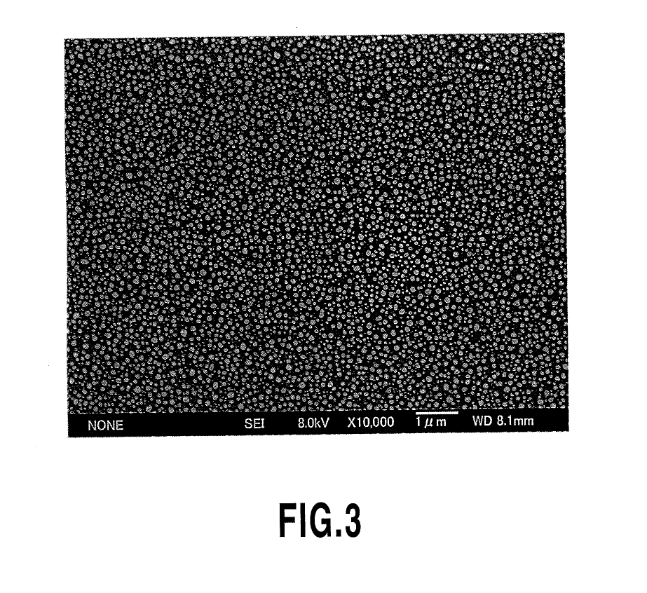

FIG. 3 shows a typical SEM image (scanning electron microscope image) of the island-shaped fine particles 5 obtained by the inventors carrying out the first embodiment. From this, it has been shown that the island-shaped fine particles 5 can be randomly formed on the surface of the substrate 2 at intervals equal to or less than the wavelength of the target light source. From the SEM image, it has been shown that, according to the first embodiment, a substance containing silver as the main component is effective as an effective material for the thin film 4.

Through verification tests of the first embodiment, the inventors have also verified that the thermal reaction, the photoreaction or the gas reaction may be controlled thereby to control the aggregation reaction or the nucleation reaction of the material and thereby control the average particle diameter of the island-shaped fine particles 5 and the intervals between the island-shaped fine particles 5. Meanwhile, it has been shown that the material may be doped with an impurity thereby to control the average particle diameter of the island-shaped fine particles 5 and the intervals between the island-shaped fine particles 5.

It has been also shown that also when the oxide containing any one of gold, platinum, palladium, tungsten, bismuth and tellurium as the main component is used as the thin film for forming the island-shaped fine particles 5, the heat, light or gas decomposition function may be used thereby to control the average particle diameter of the island-shaped fine particles 5 or the intervals between the island-shaped fine particles 5.

Fluorescence intensity was measured by using a mold 1 for an optical element (which is not the optical element in itself) fabricated by using the mold 1 for an optical element having a nanostructure manufactured by the first embodiment. The results of measurement have shown that the presence of the nanostructure enables a 50-fold improvement in detection sensitivity, as compared to the case where the nanostructure is absent.

From this, it has been shown that the present invention is an approach excellent in cost reduction and productivity, because the present invention enables, using the dry process alone, formation of the substantially conical fine depressions and elevations (or the nanostructure mold face) 1′ on the surface of the substrate 2.

Meanwhile, it has been shown that the same effect can be achieved when quartz, glass, resin such as polycarbonate or PMMA, gallium nitride, gallium arsenide, indium phosphide, nickel, iron, titanium, carbon, sapphire, carbon nitride, or the like may is used as a material for the substrate 2.

### Second Embodiment

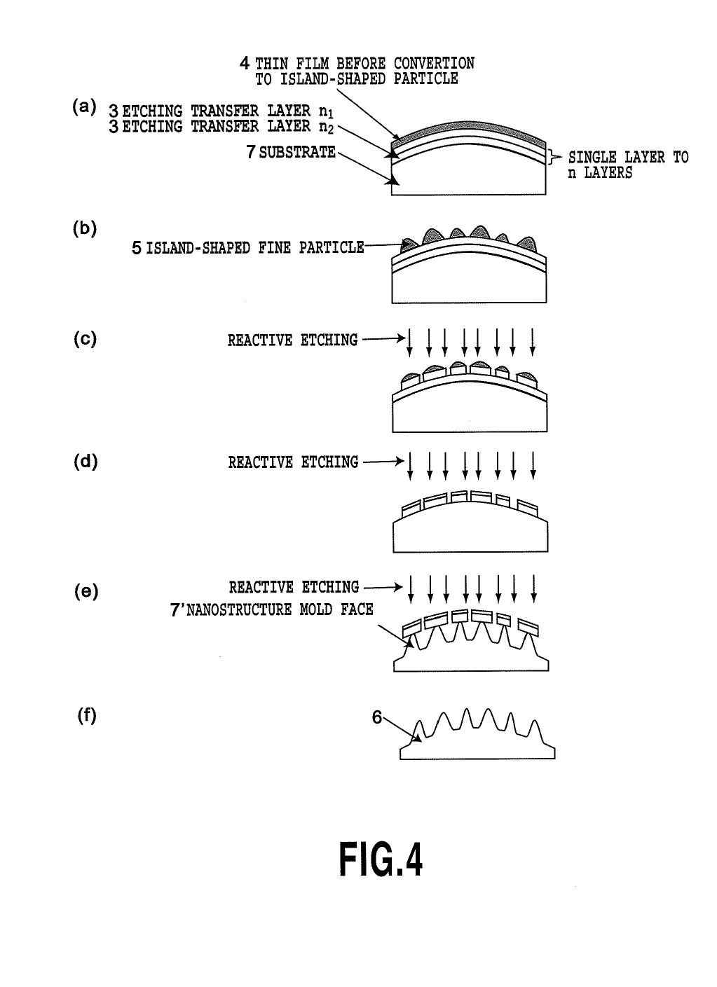

FIG. 4 is a view explaining processes in a method for manufacturing a mold 6 for an optical element according to the second embodiment of the present invention, using reactive ion etching, as in the case of the first embodiment. The second embodiment relates to a mold for an optical element for molding an optical element having a nanostructure on a substrate having a free curved surface, and the second embodiment is different from the first embodiment in that a substrate 7 has the free curved surface; however, since the manufacturing method is the same as the first embodiment, description thereof will be omitted.

In the mold 6 for the optical element having a nanostructure obtained by the manufacturing method according to the second embodiment enables, substantially conical fine depressions and elevations (or the nanostructure mold face) 1′ is formed on the surface of the substrate 6, and thereby the same effect of reflection properties as the first embodiment can be achieved.

(A Method for Manufacturing an Injection Mold, and Molding of an Optical Element Having a Nanostructure)

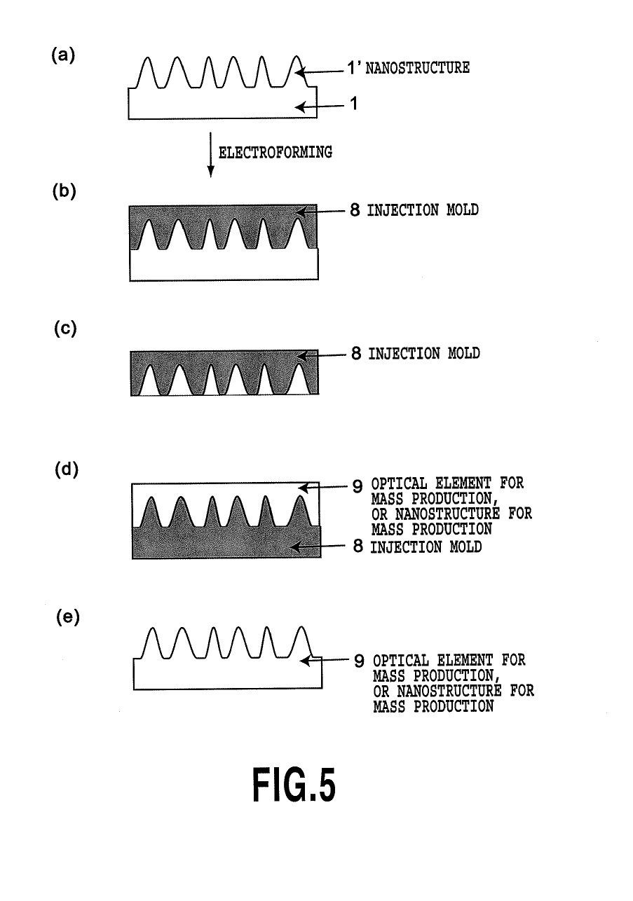

Description will now be given with reference to schematic views shown in FIG. 5 with regard to a method for manufacturing an injection mold from the mold 1 for an optical element having a nanostructure described above, and description will be given with regard to an example of a mass production method for the optical element having an nanostructure using the injection mold.

FIG. 5(a) shows the mold 1 for an optical element having a nanostructure made of silicon (or the mold 1 for an optical element having a nanostructure made of silica glass) obtained by the first embodiment of the present invention. Typical nickel electroforming is performed using the mold 1 for an optical element having a nanostructure made of silicon, as shown in FIG. 5(b), and thereby, an injection mold 8 is fabricated as shown in FIG. 5(c).

Then, the optical elements 9 each having a nanostructure as shown in FIG. 5(e) can be mass-produced by utilizing the injection mold 8 as shown in FIG. 5(d). The optical element 9 has a nanostructure formed of fine depressions and elevations on a surface of a substrate, and includes nanopatterns with a high aspect ratio in random arrangements. Preferably, the optical element 9 includes nanopatterns which are maintained at intervals equal to or less than the wavelength of a light source.

Specifically, the nanopatterns of the optical element 9 are island-shaped, and preferably, the island-shaped nanopatterns have an average particle diameter of 5 nm to 1000 nm inclusive, and an average interval between the adjacent islands is between 10 nm and 2000 nm inclusive.

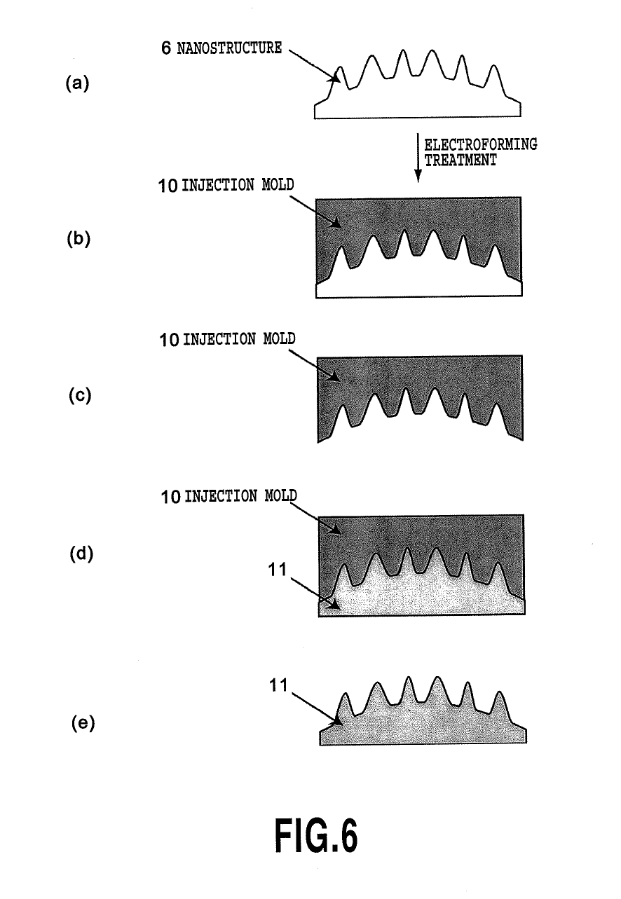

FIG. 6 is a view explaining a method using the mold 6 for an optical element having a nanostructure obtained by the second embodiment of the present invention (see FIG. 6(a)). This method is quite the same as the method shown in FIG. 5, and typical nickel electroforming is performed (see FIG. 6(b)) thereby to fabricate an injection mold 10 (see FIG. 6(c)).

Further, the optical elements 11 each having a nanostructure (see FIG. 6(e)) can also be mass-produced by injection-molding an optical element having a nanostructure by using the injection mold 10 as shown in FIG. 6(d).

### INDUSTRIAL APPLICABILITY

With the above configuration, the present invention is applicable to optical elements in general (for example, a lens for a projector, an optical pickup, a display, and the like), light emitting elements in general (for example, an LED, a laser, and the like), light receiving elements in general (a photodiode, a solar cell, and the like), a bio-analysis chip, a heat control plate, a fluid sensor, or an acceleration sensor.

1. A method for manufacturing a mold for an optical element having a nanostructure or a mold for a nanostructure, for use in molding of an optical element having a nanostructure formed of fine depressions and elevations on a surface of a substrate, comprising:
forming at least one etching transfer layer on the substrate, and forming a thin film for island-shaped fine particle formation on the etching transfer layer;
forming a plurality of island-shaped fine particles, by subjecting the thin film to any one of a thermal reaction, a photoreaction and a chemical reaction or to a combination reaction of these reactions thereby to cause any one of aggregation, decomposition, and nucleation functions of a material of the thin film; and
forming a pattern with a high aspect ratio on the fine surface of the substrate, by successively etching the etching transfer layer and the substrate using the plurality of island-shaped fine particles as a protective mask.

2. The method for manufacturing a mold for an optical element having a nanostructure or a mold for a nanostructure according to claim 1, wherein the plurality of island-shaped particles are each in hemispherical shape, and are of sizes of the order of nanometers, so that nanopatterns are formed in random arrangements with intervals therebetween each maintained to be equal to or less than a wavelength of a target light source.

3. The method for manufacturing a mold for an optical element having a nanostructure or a mold for a nanostructure according to claim 1, wherein a material for the thin film is a substance containing any one of silver, gold, platinum and palladium as a main component, or is any one of an oxide and a nitride each containing any one of silver, gold, platinum, palladium, tungsten, bismuth and tellurium as a main component.

4. The method for manufacturing a mold for an optical element having a nanostructure or a mold for a nanostructure according to claim 1, wherein the island-shaped fine particles have an average particle diameter of 5 nm to 1000 nm, and an average interval between the plurality of island-shaped fine particles is from 10 nm to 2000 nm.

5. The method for manufacturing a mold for an optical element having a nanostructure or a mold for a nanostructure according to claim 1, wherein the substrate is made of any one of a metal and a nonmetal containing any one of silica glass, resin, silicon, gallium nitride, gallium arsenide, indium phosphide, nickel, iron, titanium, carbon, sapphire and carbon nitride as a main component.

6. The method for manufacturing a mold for an optical element having a nanostructure or a mold for a nanostructure according to claim 1, wherein the etching transfer layer is constructed of a single layer formed of any one of an oxide, a nitride and a carbide, or is constructed of multiple layers each formed of any one of an oxide, a nitride and a carbide.

7. A mold for an optical element having a nanostructure, which is manufactured by the method for manufacturing a mold for an optical element, comprising:
forming at least one etching transfer layer on the substrate, and forming a thin film for island-shaped fine particle formation on the etching transfer layer;
forming a plurality of island-shaped fine particles, by subjecting the thin film to any one of a thermal reaction, a photoreaction and a chemical reaction or to a combination reaction of these reactions thereby to cause any one of aggregation, decomposition, and nucleation functions of a material of the thin film; and
forming a pattern with a high aspect ratio on the fine surface of the substrate, by successively etching the etching transfer layer and the substrate using the plurality of island-shaped fine particles as a protective mask.

8. An optical element having a nanostructure formed of fine depressions and elevations on a surface of a substrate and comprising nanopatterns with a high aspect ratio in random arrangements.

9. The optical element according to claim 8, wherein the nanopatterns of the optical element having a nanostructure are maintained at intervals equal to or less than a wavelength of a light source.

10. A mold for a nanostructure, which is manufactured by the method for manufacturing a mold for a nanostructure, comprising:
forming at least one etching transfer layer on the substrate, and forming a thin film for island-shaped fine particle formation on the etching transfer layer;
forming a plurality of island-shaped fine particles, by subjecting the thin film to any one of a thermal reaction, a photoreaction and a chemical reaction or to a combination reaction of these reactions thereby to cause any one of aggregation, decomposition, and nucleation functions of a material of the thin film; and
forming a pattern with a high aspect ratio on the fine surface of the substrate, by successively etching the etching transfer layer and the substrate using the plurality of island-shaped fine particles as a protective mask.
